(19) United States
(12) Patent Application Publication
(10) Pub. No.: US 2014/0143404 A1
(43) Pub. Date: May 22, 2014

(54) SYSTEM AND METHOD FOR COMMUNICATING WITH MULTIPLE DEVICES

(71) Applicant: SONY CORPORATION, Tokyo (JP)

(72) Inventors: Sean KENNEDY, San Diego, CA (US); Miyuki KUROIWA, Temecula, CA (US); Srujana YEDULAPURAM, San Diego, CA (US); Craig Robert WESSMAN, San Diego, CA (US); Frank SLEEPER, San Diego, CA (US); Gary LYONS, San Diego, CA (US); Leland TREEBS, San Diego, CA (US); Jenny DONG, Temecula, CA (US); Eiji TAKAHASHI, Nagano (JP)

(73) Assignee: SONY CORPORATION, Tokyo (JP)

(21) Appl. No.: 13/680,992

(22) Filed: Nov. 19, 2012

(51) Int. Cl. G06F 11/30

(52) U.S. Cl. CPC G06F 11/3006
USPC 709/224

(57) ABSTRACT

Certain aspects of a method and system for communicating with multiple devices may include a network that is capable of communicatively coupling a plurality of peripheral devices to a server. The server may be operable to receive a first set of instructions from a first of the plurality of peripheral devices and transcode the received first set of instructions to a second set of instructions. The transcoded second set of instructions may be communicated to at least one other of the plurality of peripheral devices. The first set of instructions may be based on a first communication protocol and the second set of instructions may be based on a second communication protocol.

### CROSS-REFERENCE TO RELATED APPLICATIONS/INCORPORATION BY REFERENCE

None.

### FIELD

Certain embodiments of the disclosure relate to a system and a method for communication. More specifically, certain embodiments of the disclosure relate to a method and system for communicating with multiple devices that operate on different communication protocols.

### BACKGROUND

Communication technologies have significantly improved over recent years, leading to diversified communication devices. Concomitant with such prolific developments is a variety of communication protocols and associated platforms. In general, each communication protocol may have a standard specification for operation and implementation. A communication device may need to be compatible with one or more of these standard specifications to be able to communicate with other communication devices. For example, two communication devices may not be able to share data amongst themselves, if they do not support at least one common communication protocol. In addition, communication devices may have multiple and varied communication interfaces that may pose a challenge in achieving interoperability between the communication devices.

Further limitations and disadvantages of conventional and traditional approaches will become apparent to one of skill in the art, through comparison of such systems with some aspects of the present disclosure as set forth in the remainder of the present application with reference to the drawings.

### SUMMARY

A system and/or method is provided for communication with multiple devices substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a computing environment for communicating with a plurality of peripheral devices, in accordance with an embodiment of the disclosure.

FIG. 2 is a block diagram illustrating a server, in accordance with an embodiment of the disclosure.

FIG. 3 is a diagram illustrating an exemplary architecture of the server, in accordance with an embodiment of the disclosure.

FIG. 4 is a diagram illustrating a method for communication with multiple devices, in accordance with an embodiment of the disclosure.

FIG. 5 is a flow chart illustrating authentication of a user, in accordance with an embodiment of the disclosure.

FIG. 6 is a flow chart illustrating user interaction with the server, in accordance with an embodiment of the disclosure.

### DETAILED DESCRIPTION

Certain implementations may be found in a system and/or method for communication with multiple devices. Exemplary aspects of a method for communication may include a network that is capable of communicatively coupling a plurality of peripheral devices to a server. In an embodiment, the server may be operable to discover one or more of the plurality of peripheral devices. A first set of instructions may be received from a first of the one or more discovered peripheral devices. The received first set of instructions may be transcoded to a second set of instructions. The second set of instructions may be communicated to at least one other of the one or more discovered peripheral devices. The first set of instructions may be based on a first communication protocol and the second set of instructions may be based on a second communication protocol.

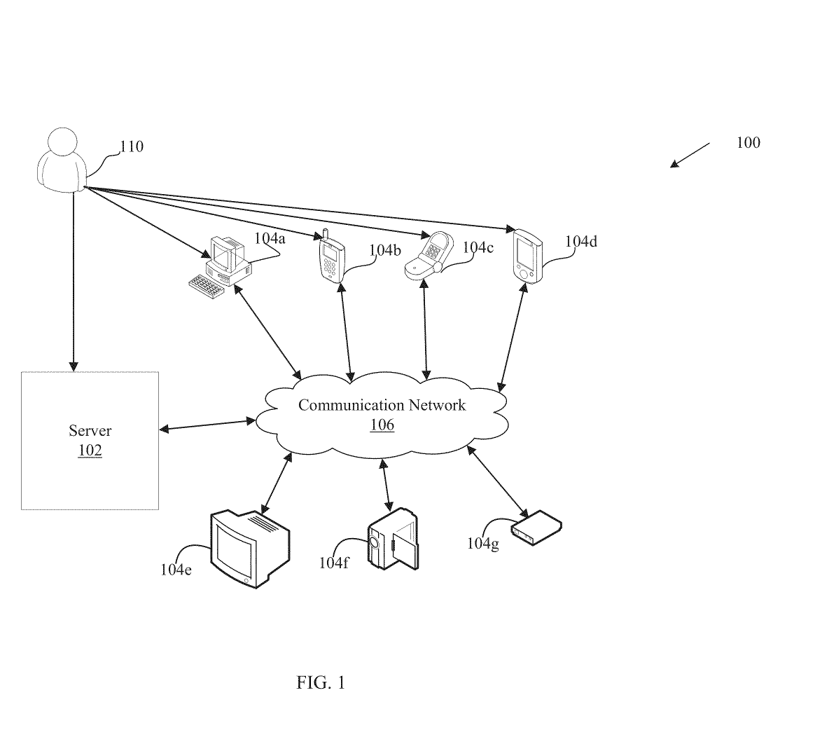

FIG. 1 is a block diagram illustrating a computing environment for communicating with a plurality of peripheral devices, in accordance with an embodiment of the disclosure. Referring to FIG. 1, there is shown a computing environment 100. The computing environment 100 may comprise a server 102, a plurality of peripheral devices 104 (104a, 104b, 104c, 104d, 104e, 104f, 104g), a communication network 106, and a user 110.

The server 102 may comprise suitable logic, circuitry, interfaces, and/or code that may enable communication with the plurality of peripheral devices 104, either directly or via the communication network 106. The user 110 may interact with the server 102 directly. In other embodiments, the user 110 may issue commands or instructions indirectly to the server 102, via one or more of the plurality of peripheral devices 104. In an embodiment, the server 102 may be implemented as a cloud-based server. The server 102 may be implemented in a personal computing cloud and may be communicatively coupled to the plurality of peripheral devices 104. In certain embodiments, the peripheral devices 104 may function as portals to the server 102.

The peripheral devices 104 may include one or more of a computer, a smart phone, a mobile device, a personal digital assistant (PDA), a laptop, a tablet PC, consumer devices or appliances, such as, a television, wireless speakers, a digital media center, a car stereo, a household power system, and/or a blender. Notwithstanding, the disclosure may not be so limited and other types of peripheral devices may be communicatively coupled to the server without limiting the scope of the disclosure. For example, the peripheral devices 104 may also include a smart device that implements a widget application that allows a user to send commands, receive content, and play the received content. The peripheral devices 104 may also include a command sub-station device such as a portable input/output device used for tracking user location, allowing user to send commands, receiving content, and playing content. The peripheral devices 104 may also include a wireless speaker set which can receive and play streamed content. The peripheral devices 104 may also include an environmental device that can alter the environment in some way (light controller or air conditioner).

The peripheral devices 104 may include any computing device capable of transmitting and/or receiving instructions and commands to the server 102, based on a user input. The peripheral devices 104 may implement various communication protocols for transmission and/or reception of data and instructions via the communication network 106.

The communication network 106 may include a medium through which the various peripheral devices 104 in the computing environment 100 may communicate with each other. Examples of the communication network 106 may include, but are not limited to, the Internet, a Wireless Fidelity (WiFi) network, a Wireless Local Area Network (WLAN), a Local Area Network (LAN), a telephone line (POTS), or a Metropolitan Area Network (MAN). Various devices in the computing environment 100 may be operable to connect to the communication network 106, in accordance with various wired and wireless communication protocols, such as, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

The user 110 may be, for example, a system administrator who operates the server 102. In an embodiment, the user 110 may be the owner of one or more of the peripheral devices 104. The user 110 may configure a personal computing environment that may include the peripheral devices 104. In an embodiment, the user 110 may configure the server 102 to control and/or manage one or more of the plurality of peripheral devices 104.

In operation, the server 102 may receive a first set of instructions from a first peripheral device, for example, 108a. The server 102 may be operable to transcode the received first set of instructions to generate a second set of instructions. The server 102 may be operable to communicate the transcoded second set of instructions to at least one other (for example, 108b) of the plurality of peripheral devices 104. The first set of instructions may be based on a first communication protocol, for example, Bluetooth communication protocol. The second set of instructions may be based on a second communication protocol, for example, Zigbee communication protocol. Notwithstanding, the disclosure may not be so limited and other communication protocols may be utilized to transmit and/or receive the set of instructions without limiting the scope of the disclosure. In one embodiment, the first and second communication protocols may be the same communication protocol.

In an embodiment, the server 102 may be operable to discover one or more of the plurality of peripheral devices 104 when the peripheral devices 104 are within a communication range of the server 102. In another embodiment, the server 102 may be operable to discover one or more of the plurality of peripheral devices 104, based on their activity status or connectivity to the communication network 106. In an embodiment, the server 102 implements messaging protocols to discover one or more of the plurality of peripheral devices 104. In another embodiment, the server 102 may be operable to determine a type of device to be communicatively coupled to the server based on the discovery of one or more of the plurality of peripheral devices 104.

In an embodiment, the server 102 may be operable to select one or more commands to communicatively couple at least one other peripheral device (for example. 108b) based on the received first set of instructions. Such commands may be pre-stored in the server 102. The one or more commands include one or more of a data sharing command, an execution command, an activation command, an input command, an output command, a control command, and/or a de-activation command.

In an embodiment, the server 102 may be operable to register the peripheral devices 104. During such a registration process, the server 102 may be operable to gather data associated with peripheral devices 104. Such data may include, but is not limited to, device type, device specification, supported protocol(s), pairing password(s), and the like. In an embodiment, the registration process may be triggered by a user input from a user 110 who may provide such details to the server 102.

In an embodiment, the server 102 may be operable to receive a user input via a user interface on the server 102. The user interface may include one or more configuration options associated with controlling and/or managing the peripheral devices 104 and the server 102. In an alternative embodiment, the server 102 may also be operable to receive the user input via a peripheral device (for example, 108a). In such an embodiment, the user input may correspond to a request to execute the received first set of instructions at another peripheral device (for example, 108b). The user input may include one or more of user defined settings, user preferences, device preferences, device ID, set of instructions, a user ID, a password, a visual input, an audio input, a gesture input, a voice command, a touch input, a location input, a text input, a face image, and/or a fingerprint image.

In an embodiment, the server 102 may be operable to authenticate a user 110 providing the user input. The server 102 may implement one or more algorithms for user recognition and/or user identification. Examples of such algorithms include, but are not limited to, face recognition algorithm, voice recognition algorithms, iris recognition algorithms, password matching algorithms, and/or fingerprint matching algorithms. The server 102 may also be operable to authenticate the user 110 based on one or more of motion detection, visual recognition, audio recognition, gesture recognition, characteristic recognition, location based recognition, and/or one or more user behavior patterns of the user 110. Notwithstanding, the disclosure may not be so limited and any unique characteristic of the user may be accepted as a user input for authentication purposes without limiting the scope of the disclosure. In another embodiment, the server 102 may be operable to create a user profile for the user 110 based one or both of the received first set of instructions and/or the second set of instructions. Such a user profile may include various other details specific to the user, such as, but not limited to, user ID, password, user metadata, user preferences, user defined configuration settings, and user's smart device ID.

The server 102 may be operable to dynamically update the user profile of the user 110 based on one or more user behavior patterns of the user 110. The one or more user behavior patterns of the user 110 may be determined based on one or more artificial intelligence algorithms. For instance, the server 102 may implement various metrics, heuristics and ranking algorithms to learn about different users and their associated peripheral devices 104. The artificial intelligence algorithms may be based on one or more of a command list, a content list, and/or a device list that are stored on the server 102. Such lists may also include details associated with communication protocols and platforms for various devices registered with the server 102 by the user 110. In an embodiment, the heuristics and associated metrics in the artificial intelligence may be used to determine and/or predict a communication protocol or a platform of the device that is intended to receive the second set of instructions.

For example, the server 102 may be operable to transcode the received first set of instructions to the second set of instructions based, at least in part, on such artificial intelligence. Further, the server 102 may be operable to select a peripheral device (for example, 104) for communication based on such artificial intelligence.

In general, the server 102 may be operable to communicate with the peripheral devices 104 without regard to the communication protocols supported at each of the peripheral devices 104. The disclosed embodiments provide for a centralized system, such as, a server 102, for providing a universal platform for interoperability between the peripheral devices 104.

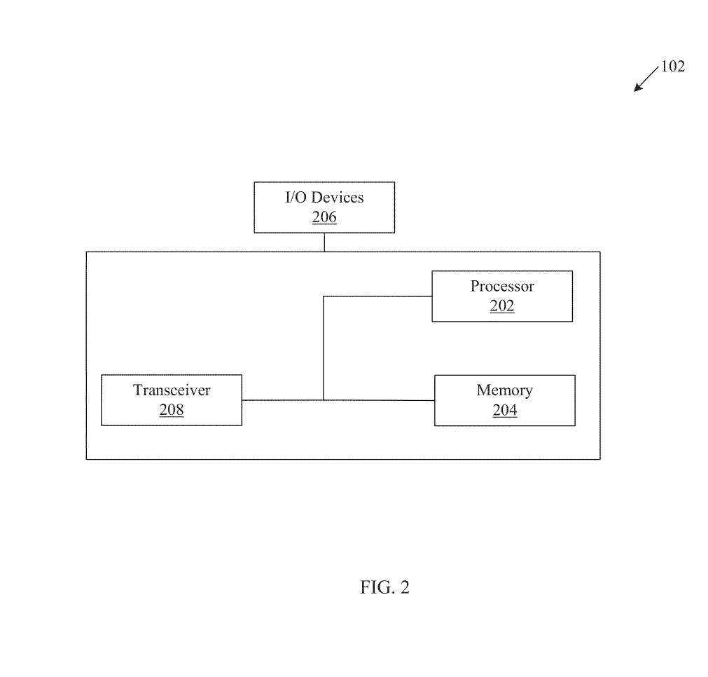

FIG. 2 is a block diagram of the server, in accordance with an embodiment of the disclosure. FIG. 2 is explained in conjunction with elements from FIG. 1. Referring to FIG. 2, there is shown the server 102. The server 102 may comprise a processor 202, a memory 204, Input-Output (I/O) devices 206, and a transceiver 208.

The processor 202 may be communicatively coupled to the memory 204, and the I/O devices 206. Further, the transceiver 208 may be communicatively coupled to the processor 202, the memory 204, and the I/O devices 206.

The processor 202 may comprise suitable logic, circuitry, interfaces, and/or code that may be operable to execute a set of instructions stored in the memory 204. The processor 202 may be implemented based on a number of processor technologies known in the art. Examples of processor 202 may be an X86-based processor, a RISC processor, an ASIC processor, a CISC processor, or any other processor.

The memory 204 may comprise suitable logic, circuitry, interfaces, and/or code that may be operable to store the received set of instructions. The memory 204 may be implemented based on, but not limited to, a Random Access Memory (RAM), a Read-Only Memory (ROM), a Hard Disk Drive (HDD), a storage server and/or a secure digital (SD) card.

The I/O devices 206 may comprise various input and output devices operably connected to the processor 202. Examples of input devices include, but are not limited to, a keyboard, a mouse, a joystick, a touch screen, a microphone, a camera, a motion sensor, a light sensor, and/or a docking station. Examples of output devices include, but are not limited to, a display and a speaker.

The transceiver 208 may comprise suitable logic, circuitry, interfaces, and/or code that may be operable to communicate with one or more of the plurality of peripheral devices (for example, 104) via a first communication interface. In an embodiment, the transceiver 208 may be operable to communicate with one or more peripheral devices 104. The transceiver 208 may implement known technologies for supporting wired or wireless communication with the communication network 106.

In operation, the processor 202 may be operable to register one or more peripheral devices 104 in order to facilitate control of the peripheral devices 104. A user interface (UI) may be provided to a user of the I/O device (for example, display screen). The processor 202 may be operable to receive a first set of instructions from a first peripheral device (for example, 104a). The processor 202 may be operable to transcode the received first set of instructions to generate a second set of instructions. The processor 202 may be operable to communicate the generated second set of instructions to at least one other peripheral device 104b. The first set of instructions and the second set of instructions may be based on different communication protocols.

In another embodiment, the server 102 may include multiple transceivers to support multiple communication protocols. In such an embodiment, each transceiver may comprise a different communication interface to communicate with the peripheral devices 104 based on the particular communication protocol. The processor 202 may be operable to activate any of these communication interfaces to receive a first set of instructions in accordance with a first communication protocol (for example, TCP/IP). The processor 202 may be operable to transcode the received first set of instructions to a second set of instructions. The transcoding may be based on knowledge of the peripheral device 104 that is intended to receive the set of instructions. For example, the first set of instructions may be intended for peripheral device 104b that supports the Bluetooth (BT) communication protocol. The transcoding of the first set of instructions may be performed accordingly. Further, the processor 102 may activate any of the multiple communication interfaces that support BT communication to communicate the second set of instructions to the intended peripheral device 104.

In an embodiment, the processor 202 may utilize one or more message conversion algorithms to convert the received first set of instructions to a second set of instructions.

The multiple communication interfaces and corresponding transceivers may enable universal interoperability between the peripheral devices 104 without regard to the communication protocols supported by each of the peripheral devices 104.

In an embodiment, the processor 202 may enable a system administrator or a user 110 to configure one or more settings associated with the peripheral devices 104 and the server 102. To this end, a UI may be provided to the system administrator. Such a UI may include various configuration options for different aspects of device interoperability associated with the peripheral devices 104. In an embodiment, the UI may include policy definitions and preferences for different types of commands or instructions.

In an embodiment, the server 102 may be operable to manage a local or a remote database to store data associated with the peripheral devices 104. Such a database may be configured to store media, records, device data, and metadata, for example. One or more of the plurality of peripheral devices 104 may be operable to access such data by communicating a set of instructions to the server 102. The peripheral devices 102 may also communicate requests for data that is stored in other peripheral devices. The server 102 may be operable to process such requests and communicate the request to other peripheral devices for data retrieval. In an embodiment, the server 102 may be operable to store a local copy of the data retrieved for a future user input. The server 102 may provide the local copy of the data when a future request is received thereby reducing the processing time of the future retrieval request. The server 102 may also reduce the burden on the peripheral devices 104 with regard to processing and storage requirements.

The server 102 may implement various architectural layers to support communication between different peripheral devices 104 without regard to communication and device protocols supported at each of the plurality of peripheral devices 104.

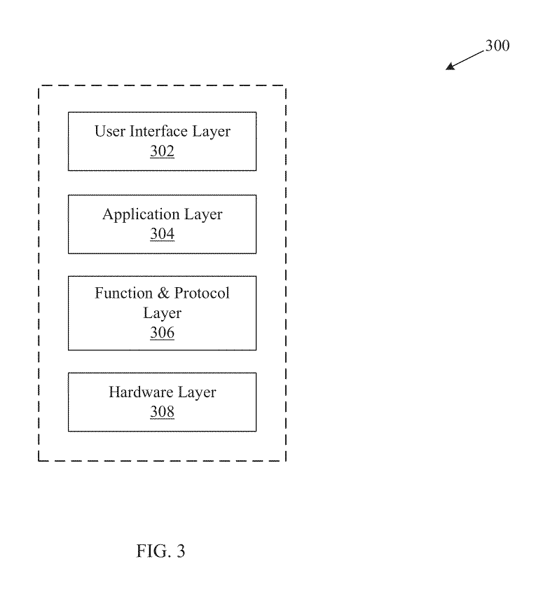

FIG. 3 is a diagram illustrating an exemplary architecture of the server 102, in accordance with an embodiment of the disclosure. Referring to FIG. 3, there is shown a plurality of layers in the architecture of the server 102. The layers may include a user interface (UI) layer 302, an application layer 304, a function and protocol layer 306, and a hardware layer 308. Each of these layers can be implemented using software or hardware or a combination of both. Notwithstanding, the disclosure may not be so limited and the server 102 may be implemented using one or more other layers without limiting the scope of the disclosure.

The UI layer 302 may implement a UI that is provided to a system administrator or a user 110. The UI may include options for configuring one or more settings of the server 102. A user 110 may provide inputs via the I/O devices 206. In various embodiments, a user input may be provided, such as a touch input, a keyboard input, a mouse input, a voice input, a visual input, an audio input, a location input, and/or a gesture input. The UI layer 302 may also implement a facial recognition interface. For example, a UI may prompt the user 110 to complete a facial recognition test before authorization. In another example, a camera may capture the user's image and the processor 202 may process the image using image processing algorithms, for example.

The application layer 304 may implement artificial intelligence (AI), decision making algorithms, a command matrix, a content list, a device list, and/or facial recognition algorithms. The AI may enable the server 102 to apply machine learning algorithms to study user pattern behavior and a pattern of user interaction or communication with the server 102. The AI may build upon history of one or more of user commands, set of instructions, device selections, and/or configuration settings to predict future interactions and user commands. The content list may include details of content transmitted from one peripheral device to the other. For example, a set of instructions may involve streaming of multimedia content in a particular format from a peripheral device (for example, 104a) to another peripheral device (for example, 104b).

In an embodiment, the processor 202 may be operable to determine content type and device-content mapping using the content list. The device list may include details of devices registered to the server 102. The device list may also include dynamic updates regarding the discovery of registered and/or unregistered peripheral devices 104. In an embodiment, the discovery of peripheral devices 104 may be a function of communication range of the server 102. The application layer 304 may also include one or more applications for carrying out various functionalities as described in the specification. For example, the application layer 304 may include facial recognition algorithms. The processor 202 may be operable to access and execute the facial recognition algorithms to recognize a user based on an image of at least a portion of the user's face. Notwithstanding, the disclosure may not be so limited and the application layer 304 may include various other applications without limiting the scope of the disclosure.

The function and protocol layer 306 may implement various communications protocols, input and output exchange controls, and/or remote device protocols. The communication protocols may correspond to a system of digital message formats and rules for exchanging the messages in or between peripheral devices 104. A communication protocol may have a formal description or a standard specification. The communication protocols may include messaging protocols, signaling protocols, authentication protocols, and/or error detection and correction protocols. A typical protocol definition may define syntax, semantics, and synchronization of communication between devices. The remote device input protocols may include remote user interface protocols. In an embodiment, the remote device input protocols may include specifications for remote user recognition by one of more of face detection, voice recognition, gesture recognition, and/or iris detection.

In an embodiment, the hardware layer 308 may implement the memory 204, the processor 202, the I/O devices 206, the transceiver 208, communication interfaces and/or ports. In addition, the hardware layer 308 may include additional components and/or circuitry for carrying out various functionalities of the server 102.

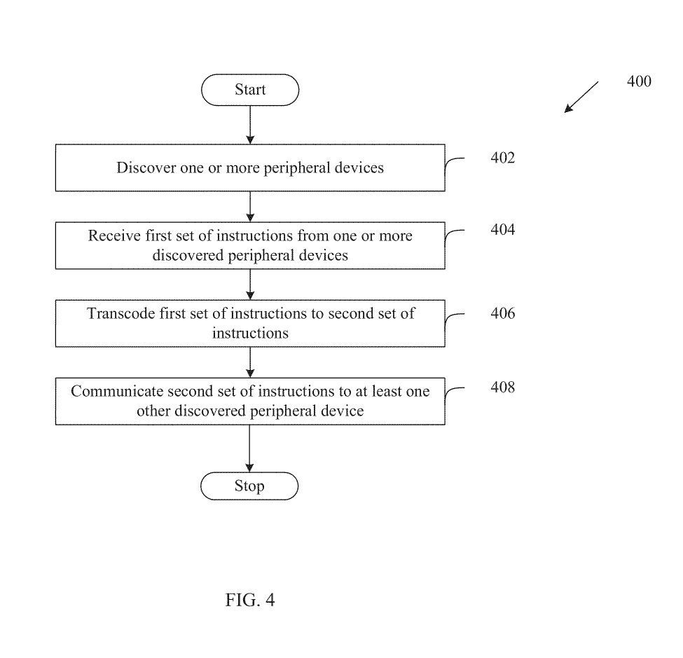

FIG. 4 is a diagram illustrating a method 400 for communication with multiple devices, in accordance with an embodiment of the disclosure. The method 400 may be implemented in a network comprising a plurality of peripheral devices 104 communicatively coupled to the server 102. FIG. 4 will be described in conjunction with elements of FIG. 1 and FIG. 2.

At step 402, one or more of the plurality of peripheral devices 104 may be discovered by the server 102 based on one or more discovery or messaging protocols. In an embodiment, the discovery of the peripheral devices 104 may be a function of the communication range of the server 102 and/or the peripheral devices 104. In another embodiment, the discovery may depend on the status of operation of the peripheral devices 104. For example, a peripheral device (for example, 104a) may have an “active status” when the peripheral device is connected to the communication network 106. The processor 202 may maintain and/or update a list of discovered peripheral devices. In an embodiment, the peripheral devices 104 may be pre-registered with the server 102 so that they can be discovered by the server 102.

At step 404, the processor 202 may be operable to receive the first set of instructions from the discovered peripheral device (for example, 104a).

At step 406, the processor 202 may be operable to transcode the received first set of instructions to generate the second set of instructions.

At step 408, the processor 202 may be operable to communicate the second set of instructions to another peripheral device (for example, 104b). In one embodiment, different peripheral devices 104 may support different communication protocols. Therefore, the first set of instructions may correspond to a first communication protocol and the second set of instructions may correspond to a second communication protocol.

In an embodiment, the method 400 may include a step of providing a user interface to control and/or manage the plurality of peripheral devices 104. The user can provide inputs in various forms to configure settings associated with the server 102 and/or the peripheral devices 104.

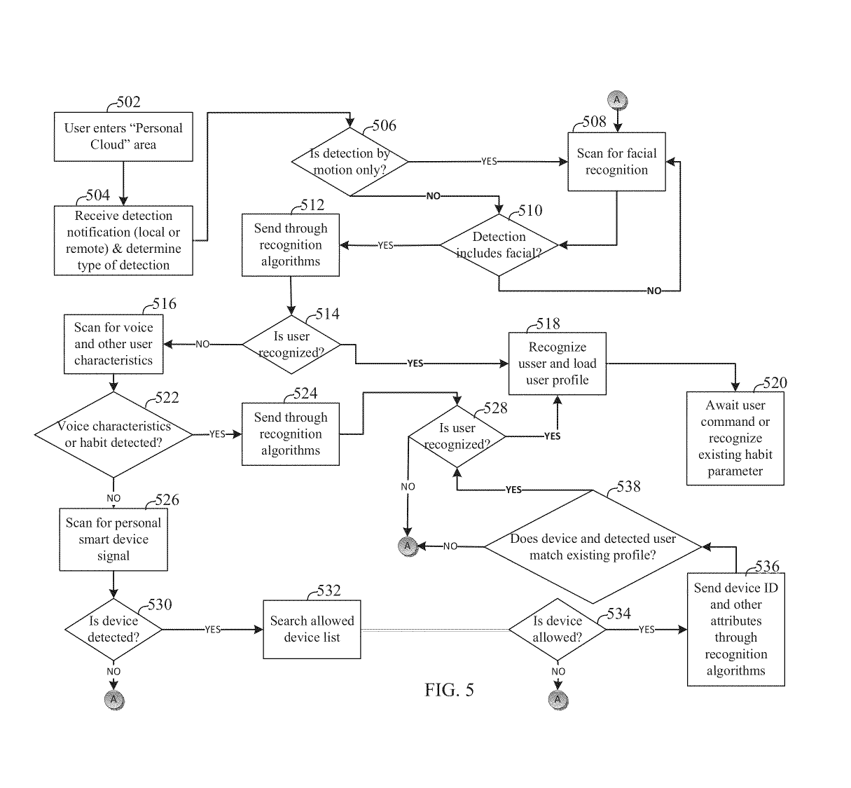

FIG. 5 is a flow chart illustrating authentication of a user, in accordance with an embodiment of the disclosure. FIG. 5 will be described in conjunction with elements of FIG. 1 and FIG. 2.

At step 502, a user 110 may enter a “personal cloud” area. In an embodiment, a personal cloud may refer to a cloud computing environment (for example, computing environment 100 as shown in FIG. 1) that includes peripheral devices 104 communicatively coupled to the server 102 via the communication network 106. At step 504, the server 102 may determine a location of the user, for example, local or remote and determine a type of detection. At step 506, the server 102 may determine whether the detection is based on motion of the user. If the determination is based on motion of the user, control passes to step 508, otherwise the control passes to step 510.

At step 508, one or more of the I/O devices 206 may be operable to receive an image of at least a portion of the user's face for facial recognition. In an embodiment, a camera connected to the server 102 may capture an image of the user 110.

At step 510, the server 102 may determine whether the detection of the user 110 includes a facial image of the user. If the detection of the user 110 includes a facial image of the user, control passes to step 512, otherwise the control returns to step 508.

At step 512, the server 102 may process the facial image using one or more facial recognition algorithms.

At step 514, the server 102 may determine whether the user 110 is authorized to control and/or manage the peripheral devices 104 in the personal cloud. If the user 110 is recognized based on facial recognition, the control passes to step 518, otherwise the control passes to step 516.

At step 518, the server 102 may load the user profile of the recognized user.

At step 520, the server 102 may wait for a user input or command. In an embodiment, the server 102 may wait for an existing habit or a pattern that can be recognized.

Returning to step 516, the server 102 may receive an input of the user's voice and/or other characteristics. Other characteristics may include habit or behavior pattern, iris print, finger print, and/or the like. The control then passes to step 522.

At step 522, the server 102 may determine whether voice and other user characteristics have been detected. If the voice and other user characteristics have been detected, the control passes to step 524, otherwise the control passes to 526.

At step 524, the server 102 may process the voice and other user characteristics using one or more recognition algorithms. At step 526, the server 102 scans for any signal from a peripheral device.

At step 530, the server 102 may determine whether any personal smart device is detected. If a personal smart device is detected, the control passes to step 532, otherwise the control returns to step 508.

At step 532, the server 102 may search a list of allowed devices to check whether the detected device is allowed or authorized. At step 534, the server 102 may determine whether the detected device is allowed to send commands or instructions. If the detected device is allowed to send commands or instructions, the control passes to step 536, otherwise the control returns to 508. At step 536, the server 102 may process the detected device's ID and other attributes using one or more recognition algorithms. At step 538, the server 102 may determine whether the recognized device and the associated user match any existing profile. If the recognized device and the associated user match an existing profile, the control passes to step 528, otherwise the control returns to step 508. At step 528, the server 102 determines whether the user is recognized as an authorized user. If the determination is positive, the control passes to step 518, otherwise the control passes to step 508.

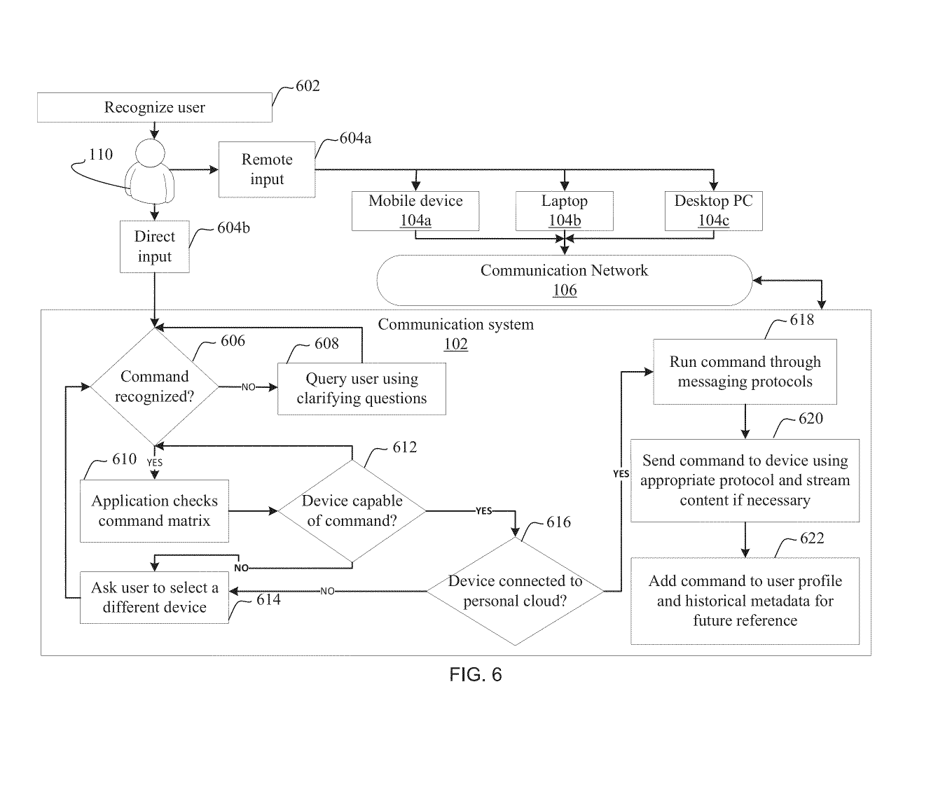

FIG. 6 is a flow chart illustrating user interaction with the server, in accordance with an embodiment of the disclosure. FIG. 6 will be described in conjunction with elements of FIG. 1, FIG. 2, and FIG. 3.

Referring to FIG. 6, at step 602, a user 110 may be recognized by the server 102. The user 110 may provide an input to the server 202. In an embodiment, the user 110 may provide a remote input 604a via one of the peripheral devices, such as, mobile device 104a, laptop device 104b, or desktop PC 104c. In an embodiment, the user 110 may provide a direct input 604b to the server 102. The server 102 may receive and process the remote input 604a and/or direct input 604b. In an embodiment, the user input may correspond to a command or a set of instructions intended to be executed at a device (for example, peripheral device 104a).

At step 606, the server 102 may determine whether the command corresponding to the received input can be recognized. If the command is not recognized, control passes to step 608, otherwise control passes to step 610. At step 608, the server 102 may query the user 110 based on clarifying questions to better understand the input from the user 110. The query may include additional details, such as, device name, device type, or priority of command, for example.

At step 610, the application layer 304 implemented in the server 102 may check a command matrix to determine the command type and any additional details that the command matrix may include. In an embodiment, the command matrix may include a list of commands with additional details, such as, command type, frequency of each command, priority of each command relative to other commands, content requirement for each command, and the like.

At step 612, the server 102 may determine whether the device specified in the command is capable of executing the command. If the device specified in the command is not capable of executing the command, the control passes to step 614, otherwise the control passes to step 616. At step 614, the server 102 may prompt the user 110 to select a different device other than the one specified in the command. The user 110 may select a different device via a user interface provided by the server 102. The control then returns to step 606.

At step 616, the server 102 may determine whether the device specified in the command is connected to a personal cloud. In an embodiment, the personal cloud may refer to the computing environment 100 (for example, as shown in FIG. 1) that includes peripheral devices 104 communicatively coupled to the server 102 via the communication network 106. It is referred to as “personal” to signify customized and personalized control and management of the devices in the cloud computing environment. If the device specified in the command is not connected to a personal cloud, the control returns to step 614, otherwise the control passes to 618. At step 618, the functional and protocol layer 306 implemented in the server 102 may process the command using various messaging protocols. In an embodiment, such processing may include transcoding the command to a format that would be supported at the peripheral device intended to execute the command.

At step 620, the server 102 communicates the transcoded command using an appropriate communication protocol. The server 102 may stream content if required for executing the command. At step 622, the server 102 may update the user profile and a historical metadata repository based on the command for future reference.

Certain embodiments of the systems and methods disclosed herein may have the ability to intelligently track the user by location, and by recognition, to provide environmental changes. For example, the user comes home at 1 AM, to a dark house. Using this data, the system may decide to turn on the lights for the user. In another example, during summers when the temperature outside is 98 degrees, the user leaves his work place and has a 45 minute commute to his house. Using this data, the system may decide to turn on the air conditioning so that the user's house is cool when the user reaches home.

Certain embodiments of the systems and methods disclosed herein may have the ability to intelligently track habit parameters or behavior patterns of the user to operate one or more peripheral devices. For example, on Mondays, the user always comes home at 7:30 PM and watches football on channel X. Using this data, the system may turn on the television in time to watch the game. In another example, on Mondays, the user always comes home at 7:30 PM and watches football on channel X. But on one particular evening, the user may be stuck in traffic and may not arrive home on time. Using this data, the system may turn on digital video recording (DVR) device to record the game. In yet another example, on a Friday, the user always goes from the garage to the bedroom to change clothes, and then to the kitchen to prepare dinner. Using this data, the system opens the garage door, turn on the lights of the bedroom and preheat the oven in the kitchen as soon as the user enter the detection area of the “personal cloud” or sends a command.

Certain embodiments of the systems and methods disclosed herein may have the ability to intelligently track location of the user to operate one or more peripheral devices. For example, the user is listening to music in the living room, but goes outside to water the lawn. The system may track the user and stream the music to wireless speakers outside the living room.

In accordance with an embodiment of the disclosure, a system for communicating with multiple devices may comprise a communication network 106 (FIG. 1). The communication network 106 may be capable of communicatively coupling a plurality of peripheral devices 104 (FIG. 1) to a server 102 (FIG. 1). The server 102 may comprise one or more processors, for example, processor 202 (FIG. 2) that may be operable to receive a first set of instructions from a first of the plurality of peripheral devices 104a. The processor 202 may be operable to transcode the received first set of instructions to a second set of instructions. The transceiver 208 may be operable to communicate the second set of instructions to at least one other of the plurality of peripheral devices 104b. The first set of instructions may be based on a first communication protocol and the second set of instructions may be based on a second communication protocol.

In an embodiment, the one or more processors may be operable to discover one or more of the plurality of peripheral devices when one or more of the plurality of peripheral devices are within a communication range of the server. In another embodiment, the one or more processors may be operable to detect a type of device to be communicatively coupled to the server based on the discovery of one or more of the plurality of peripheral devices.

In an embodiment, the one or more processors may be operable to select one or more commands to communicatively couple at least one other of the plurality of peripheral devices based on the received first set of instructions. In yet another embodiment, the one or more commands may include one or more of a data sharing command, an execution command, an activation command, an input command, an output command, a control command, and/or a de-activation command.

In an embodiment, the one or more processors may be operable to receive a user input via one or both of a user interface on the server and/or one or more of the plurality of peripheral devices. In another embodiment, the received user input may correspond to user defined settings for controlling the plurality of peripheral devices.

In an embodiment, the received user input may include one or more of a visual input, an audio input, a gesture input, a location input, a touch input, and/or a text input. In another embodiment, the one or more processors may be operable to authenticate a user based on the received user input.

In an embodiment, the one or more processors may be operable to register the plurality of peripheral devices with the server. In another embodiment, the one or more processors may be operable to create a user profile based on one or both of the received first set of instructions and/or the communicated second set of instructions.

In an embodiment, the one or more processors may be operable to update the user profile based on one or more user behavior patterns of a user. The one or more user behavior patterns may be determined based on one or more artificial intelligence algorithms. In another embodiment, the one or more artificial intelligence algorithms may be based on one or more of a command list, a content list, and/or a device list.

In a still further embodiment, the one or more processors may be operable to transcode the received first set of instructions to the second set of instructions based, at least in part, on the artificial intelligence algorithms. In another embodiment, the one or more processors may be operable to authenticate the user based on one or more of motion detection, visual recognition, audio recognition, gesture recognition, characteristic recognition, location based recognition, and/or the determined one or more user behavior patterns of the user.

Other embodiments of the disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps comprising discovering one or more of a plurality of peripheral devices that are communicatively coupled to a server. A first set of instructions may be received from a first of the one or more discovered peripheral devices. The received first set of instructions may be transcoded to a second set of instructions. The second set of instructions may be communicated to at least one other of the one or more discovered peripheral devices. The first set of instructions and the second set of instructions may be based on different communication protocols.

Accordingly, the present disclosure may be realized in hardware, or a combination of hardware and software. The present disclosure may be realized in a centralized fashion in at least one computer system or in a distributed fashion where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A system for communication, said system comprising:
in a network capable of communicatively coupling a plurality of peripheral devices to a server, one or more processors in said server being operable to:
receive a first set of instructions from a first of said plurality of peripheral devices;
transcode said received first set of instructions to a second set of instructions; and
communicate said transcoded second set of instructions to at least one other of said plurality of peripheral devices, wherein said first set of instructions are based on a first communication protocol and said second set of instructions are based on a second communication protocol.

2. The system of claim 1, wherein said one or more processors are operable to discover one or more of said plurality of peripheral devices when said one or more of said plurality of peripheral devices are within a communication range of said server.

3. The system of claim 2, wherein said one or more processors are operable to detect a type of device to be communicatively coupled to said server based on said discovery of said one or more of said plurality of peripheral devices.

4. The system of claim 1, wherein said one or more processors are operable to select one or more commands to communicatively couple said at least one other of said plurality of peripheral devices based on said received first set of instructions.

5. The system of claim 4, wherein said one or more commands comprises one or more of: a data sharing command, an execution command, an activation command, an input command, an output command, a control command, and/or a de-activation command.

6. The system of claim 1, wherein said one or more processors are operable to receive a user input via one or both of: a user interface on said server and/or one or more of said plurality of peripheral devices.

7. The system of claim 6, wherein said received user input corresponds to user defined settings for controlling said plurality of peripheral devices.

8. The system of claim 6, wherein said received user input comprises one or more of: a visual input, an audio input, a gesture input, a location input, a touch input, and/or a text input.

9. The system of claim 8, wherein said one or more processors are operable to authenticate a user based on said received user input.

10. The system of claim 1, wherein said one or more processors are operable to register said plurality of peripheral devices with said server.

11. The system of claim 1, wherein said one or more processors are operable to create a user profile based on one or both of: said received first set of instructions and/or said communicated second set of instructions.

12. The system of claim 11, wherein said one or more processors are operable to update said user profile based on one or more user behavior patterns of a user, wherein said one or more user behavior patterns are determined based on one or more artificial intelligence algorithms.

13. The system of claim 12, wherein said one or more artificial intelligence algorithms are based on one or more of: a command list, a content list, and/or a device list.

14. The system of claim 12, wherein said one or more processors are operable to transcode said received first set of instructions to said second set of instructions based, at least in part, on said artificial intelligence algorithms.

15. The system of claim 12, wherein said one or more processors are operable to authenticate said user based on one or more of: motion detection, visual recognition, audio recognition, gesture recognition, characteristic recognition, location based recognition, and/or said determined one or more user behavior patterns of said user.

16. A method for communication, said method comprising:
in a server communicatively coupled to a plurality of peripheral devices:
discovering one or more of said plurality of peripheral devices;
receiving a first set of instructions from said discovered said one or more of said plurality of peripheral devices;
transcoding said received first set of instructions to a second set of instructions; and
communicating said transcoded second set of instructions to at least one other of said discovered said one or more of said plurality of peripheral devices, wherein said first set of instructions are based on a first communication protocol and said second set of instructions are based on a second communication protocol.

17. The method of claim 16, comprising registering one or more of said discovered plurality of peripheral devices with said server.

18. The method of claim 16, comprising receiving a user input from a user to control said plurality of peripheral devices.

19. The method of claim 18, comprising updating a user profile based on one or more user behavior patterns of said user, wherein said one or more user behavior patterns are determined based on one or more artificial intelligence algorithms.

20. A non-transitory computer-readable storage medium having stored thereon, a computer program having at least one code section for communication, the at least one code section being executable by a computer for causing the computer to perform steps comprising:
in a server communicatively coupled to a plurality of peripheral devices:
receiving a first set of instructions from a first of said plurality of peripheral devices;
transcoding said received first set of instructions to a second set of instructions; and
communicating said transcoded second set of instructions to at least one other of said plurality of peripheral devices, wherein said first set of instructions are based on a first communication protocol and said second set of instructions are based on a second communication protocol.
